(19) United States
(12) Patent Application Publication
(10) Pub. No.: US 2026/0364695 A1
(43) Pub. Date: Nov. 19, 2026

(54) LIQUID-PHASE PLASMA MACHINING APPARATUS AND METHOD BASED ON A FLOATING DISCHARGE TOOL

(71) Applicant: ZHEJIANG UNIVERSITY, HANGZHOU (CN)

(72) Inventors: Wule ZHU, HANGZHOU (CN); Fang HAN, HANGZHOU (CN); Jingyuan WANG, HANGZHOU (CN); Weijian ZHANG, HANGZHOU (CN); Wei GAO, HANGZHOU (CN); Caoyang XUE, HANGZHOU (CN); Keyi WU, HANGZHOU (CN); Bingfeng JU, HANGZHOU (CN); Daqiang GU, HANGZHOU (CN); Pinhe ZHU, HANGZHOU (CN)

(21) Appl. No.: 19/721,938

(22) Filed: Jun. 26, 2026

Related U.S. Application Data
(63) Continuation of application No. PCT/CN2025/090468, filed on Apr. 22, 2025.

(30) Foreign Application Priority Data
Apr. 22, 2025 (CN) 202510504981.1

(51) Int. Cl. B23H 3/04; B23H 3/10; B23H 7/26

(52) U.S. Cl. CPC B23H 3/04; B23H 3/10; B23H 7/26

(57) ABSTRACT

A liquid-phase plasma machining apparatus includes a workpiece base for fixing a workpiece to be processed, a working platform for placing a polishing slurry, a spindle for driving a floating tool to rotate, an aerostatic guide rail for supporting the spindle, a Z-axis manual adjustment stage for fixing the aerostatic guide rail, a Y-axis translation stage and an X-axis translation stage for adjusting a position of the workpiece base, a conductive bearing, a ground electrode, a working electrode, and an adjustable power supply. The floating tool is made of a flexible conductive material. The conductive bearing is sleeved outside the floating tool and is electrically connected to the adjustable power supply through the working electrode. The workpiece base is arranged at a side of the floating tool and is grounded through the ground electrode.

### CROSS-REFERENCE TO RELATED APPLICATIONS

This application claims the priority and benefit of Chinese patent application number 2025117780386, titled “Liquid-Phase Plasma Machining Apparatus and Method Based on a Floating Discharge Tool” and filed Nov. 28, 2025 with China National Intellectual Property Administration, the entire contents of which are incorporated herein by reference.

### TECHNICAL FIELD

The present disclosure relates to the technical field of polishing apparatuses, and relates to ultra-precision liquid-phase plasma machining, and more particularly to a liquid-phase plasma machining apparatus and method based on a floating discharge tool.

### BACKGROUND

With the widespread application of third-generation semiconductor materials such as silicon carbide (SiC) and gallium nitride (GaN) in the field of high-power devices, higher requirements have been imposed on machining equipment and process precision; however, these materials have ultra-high hardness second only to diamond, and thus how to achieve efficient and deterministic material removal while ensuring ultra-smooth surface quality remains a significant challenge.

Non-contact machining methods have the advantage of avoiding defects and subsurface damage caused by contact, thereby enabling the possibility of achieving atomic-level machining precision. Among these, floating polishing technology suspends a workpiece above a liquid film of a rotating polishing plate, and utilizes rotation of a tool to drive fluid to pass over a surface of the workpiece to generate hydrodynamic pressure, wherein the hydrodynamic pressure is balanced with a load applied in an opposite direction, such that the magnitude of the hydrodynamic pressure in floating machining can be controlled by adjusting the load, thereby achieving precise, extremely small constant-force stable machining, so that surface flatness of the workpiece can be as low as 30 nanometers; however, due to a full-aperture polishing characteristic thereof, deterministic material removal cannot be achieved, and machining accuracy is difficult to further converge. Elastic emission machining used for silicon machining is a deterministic process that can provide relatively high form control accuracy, but a material removal rate thereof is relatively low, making it difficult to meet efficiency requirements for machining hard materials. In recent years, jet-based elastic emission machining methods have been proposed, in which removal efficiency is improved by increasing an impact velocity of abrasive particles on the workpiece, but high impact forces may lead to deterioration of surface quality.

Some methods propose to first modify a surface of a workpiece to form a softened layer and then perform mechanical removal, for example, by using helium plasma to oxidize a material surface, followed by removing an oxide layer through chemical mechanical polishing. Although such a method can improve the material removal rate to a certain extent, the method requires two process steps and cannot achieve simultaneous modification and removal. Another type of method utilizes atmospheric plasma of specific reactive gases to directly etch a material to achieve atomic-level smoothness; however, such methods suffer from thermal effects and insufficient form control accuracy caused by large-area processing.

Therefore, how to improve material removal efficiency while ensuring ultra-high surface finish remains a critical challenge to be addressed in non-contact machining technologies.

### SUMMARY

In view of deficiencies in the related art, the present disclosure provides a liquid-phase plasma machining apparatus and method based on a floating discharge tool, in which liquid-phase plasma discharge is generated within a stable liquid film between a floating discharge polishing tool and a workpiece, and under a photoelectric field effect produced by the discharge, a synergistic effect of nano catalytic particles is activated to confine oxidation of surface atoms of the workpiece and reduce material hardness, thereby increasing a material removal rate, and in combination with dynamic adjustment of an aerostatic guide rail, a thickness of the liquid film is maintained constant, thereby achieving stable material removal at sub-nanometer precision and realizing both high-efficiency machining and sub-nanometer-level form accuracy control.

A liquid-phase plasma machining apparatus based on a floating discharge tool is disclosed and includes a floating discharge tool, a conductive bearing, a workpiece base, a working platform, a ground electrode, a working electrode, an adjustable power supply, a Z-axis manual stage, an aerostatic guide rail, a Z-axis bracket, a spindle, a Y-axis translation stage, and an X-axis translation stage.

The floating discharge tool is made of a flexible conductive material and is fixed at one end of the spindle. The other end of the spindle is fixed to the aerostatic guide rail via the Z-axis bracket. The aerostatic guide rail is fixed on a surface of the Z-axis manual stage. The conductive bearing is sleeved over the floating discharge tool and is electrically connected to the adjustable power supply through the working electrode.

The workpiece base is located at a side of the floating discharge tool and is fixed to the Y-axis translation stage, and the Y-axis translation stage is fixed to the X-axis translation stage, such that the workpiece base can be moved in an X-axis direction and a Y-axis direction by the Y-axis translation stage and the X-axis translation stage. The workpiece base is grounded through the ground electrode.

The working platform is located below the workpiece base.

In some embodiments, the adjustable power supply is a voltage-adjustable high-voltage pulse power supply, an alternating current power supply, or a direct current power supply.

In some embodiments, the working platform is a liftable platform.

A liquid-phase plasma machining method based on a floating discharge tool is provided, in which the above apparatus is used to polish a workpiece, and the method specifically includes the following steps:
Step 1: a workpiece to be processed is fixed on a surface of the workpiece base by conductive adhesive.
Step 2: the position of the workpiece base is controlled by the Y-axis translation stage and the X-axis translation stage so that the workpiece comes into contact with the surface of the floating discharge tool. A water tank containing polishing slurry is placed on the working platform, so that the polishing slurry immerses the floating discharge tool and the surface of the workpiece, thereby generating sufficient hydrodynamic pressure to realize floating machining.
Step 3: the spindle is controlled to drive the floating discharge tool to rotate, so that the aerostatic guide rail drives the floating discharge tool to move away from the surface of the workpiece, and the floating discharge tool deforms, thereby forming a dynamically adjustable micron-scale stable liquid film gap between the floating discharge tool and the surface of the workpiece.
Step 4: after the liquid film becomes stable, the adjustable power supply is turned on to initiate discharge, and the liquid-phase plasma discharge generates various active species in the discharge region and releases ultraviolet light and shock waves, thereby converting the surface of the workpiece into an oxide layer.
Step 5: abrasive particles in the polishing slurry pass through the liquid film gap at a relatively high linear velocity under fluid driving, come into contact with atoms on the surface of the workpiece and form chemical bonds, and are then removed together with the fluid motion, thereby achieving deterministic material removal.

In some embodiments, the workpiece is a semiconductor material or a metal material.

In some embodiments, the workpiece is doped conductive silicon carbide, silicon, zinc sulfide, gallium nitride, gallium arsenide, aluminum, iron, or copper.

In some embodiments, the abrasive particles in the polishing slurry comprise one or a combination of silica sol, aluminum oxide, cerium oxide, diamond, and silicon carbide.

In some embodiments, the polishing slurry further comprises catalytic particles, and the catalytic particles comprise one or a combination of titanium dioxide, graphitic carbon nitride, zinc oxide, and zirconium dioxide.

The present disclosure has the following beneficial effects:
1. Compared with related floating machining methods, by introducing the floating discharge tool, liquid-phase plasma discharge is realized within the stable liquid film between the floating discharge tool and the workpiece, and under the photoelectric field effect generated by the discharge, a synergistic effect of nano catalytic particles is activated to generate highly oxidative free radicals, thereby confining oxidation of surface atoms of the workpiece and reducing material hardness, and removing material under a flow field effect of floating polishing, such that modification and removal are carried out simultaneously, thereby effectively improving machining efficiency.
2. A flexible conductive rubber tool is pressed toward the workpiece under an external load, and hydrodynamic pressure generated by rotation of the spindle causes the tool to elastically deform and retreat, and the hydrodynamic pressure and the external load are balanced through movement on the aerostatic guide rail, whereby a position of the aerostatic guide rail is dynamically adjusted and a thickness of the liquid film is maintained constant, thereby achieving stable material removal at sub-nanometer precision and thus providing both high-efficiency machining and sub-nanometer-level form accuracy control capability.
3. Nano catalytic particles are introduced into the polishing slurry to further improve the material removal rate. Due to the photoelectric field generated by the liquid-phase plasma discharge, energy level transitions can be induced in titanium dioxide, and generated electron-hole pairs can further produce more highly oxidative active species, thereby synergistically improving oxidation efficiency of silicon carbide and enhancing the material removal rate.

### BRIEF DESCRIPTION OF DRAWINGS

FIG. 1 is a schematic diagram of a liquid-phase plasma machining apparatus based on a floating discharge tool.

FIG. 2 is a schematic diagram of a liquid-phase plasma discharge region.

FIG. 3 is a schematic diagram illustrating a principle of a liquid-phase plasma machining method based on a floating discharge tool.

FIG. 4 is a schematic diagram illustrating a discharge mechanism and a material removal mechanism of liquid-phase plasma based on a floating discharge tool.

### DETAILED DESCRIPTION OF EMBODIMENTS

The present disclosure is further described below with reference to the accompanying drawings.

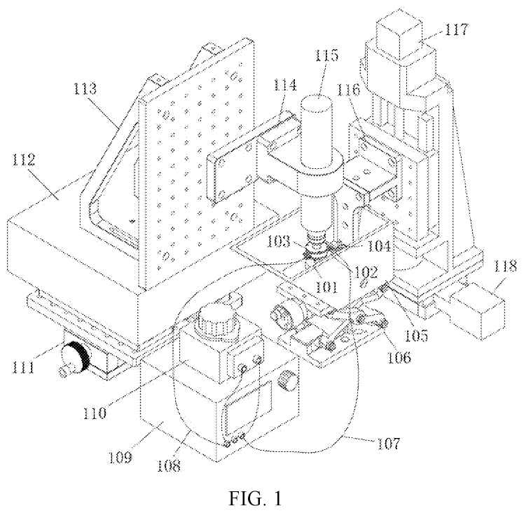

A liquid-phase plasma machining apparatus based on a floating discharge tool 101, as shown in FIG. 1, includes a floating discharge tool 101, a conductive bearing 103, a workpiece base 104, a water tank 105, a manual lifting stage 106, a ground electrode 107, a working electrode 108, a high-voltage pulse power supply 109, a voltage regulator 110, a Z-axis manual stage 111, an aerostatic guide rail 112, a Z-axis bracket 113, a spindle adapter 114, a spindle 115, a worktable adapter 116, a Y-axis translation stage 117, and an X-axis translation stage 118.

The floating discharge tool 101 is made of flexible conductive rubber and is fixed at one end of the spindle 115. Another end of the spindle 115 is fixed to the Z-axis bracket 113 through the spindle adapter 114, and the Z-axis bracket 113 is fixed on a surface of the aerostatic guide rail 112. The aerostatic guide rail 112 is fixed on a surface of the Z-axis manual stage 111. The conductive bearing 103 is sleeved over the floating discharge tool 101 and is connected to the high-voltage pulse power supply 109 through the working electrode 108, so as to transmit a high-voltage pulse signal of the working electrode 108 to an end surface of the floating discharge tool 101. Compared with related floating machining methods, by introducing the floating discharge tool 101, confined plasma discharge is generated within a liquid film gap, and a photoelectric field produced by the discharge activates nano catalysts to generate highly oxidative hydroxyl radicals, thereby confining oxidation of a SiC surface and removing material under a flow field effect of floating polishing, thus effectively improving machining efficiency.

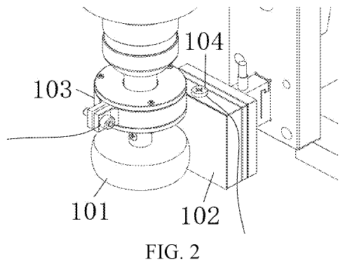

As shown in FIG. 2, the workpiece base 104 is located at a side of the floating discharge tool 101 and is fixed to the Y-axis translation stage 117 through the worktable adapter 116, the Y-axis translation stage 117 being fixed to the X-axis translation stage 118, such that the workpiece base 104 is movable in an X-axis direction and a Y-axis direction via the Y-axis translation stage 117 and the X-axis translation stage 118. The workpiece base 104 is grounded through the ground electrode 107. The manual lifting stage 106 is located below the floating discharge tool 101 and the workpiece base 104. The water tank 105 is placed on a surface of the manual lifting stage 106.

When the power supply voltage is within an appropriate range, relatively mild corona discharge is generated to produce free radicals, and an accompanying photoelectric field facilitates activation of nano catalytic particles. When the voltage is excessively high, arc discharge may occur between the floating discharge tool 101 and the workpiece 102, and the discharge becomes intense and randomly distributed, which may easily cause a large number of micro pits on a surface of the workpiece 102; therefore, the voltage regulator 110 is used to adjust an output voltage of the high-voltage pulse power supply 109. The working electrode 108 is connected to an output end of the high-voltage pulse power supply 109, and the ground electrode 107 is connected to a ground end of the high-voltage pulse power supply 109. During polishing machining, a workpiece 102 to be processed is fixed on a surface of the workpiece base 104 by conductive adhesive, thereby forming an electrical circuit between the floating discharge tool 101 and the workpiece 102 and realizing confined liquid-phase plasma discharge within the liquid film.

In one embodiment, the ground electrode 107 and the working electrode 108 are respectively connected to an alternating current power supply or a direct current power supply to realize an electrochemical catalytic process within a gap between the floating discharge tool 101 and the workpiece 102.

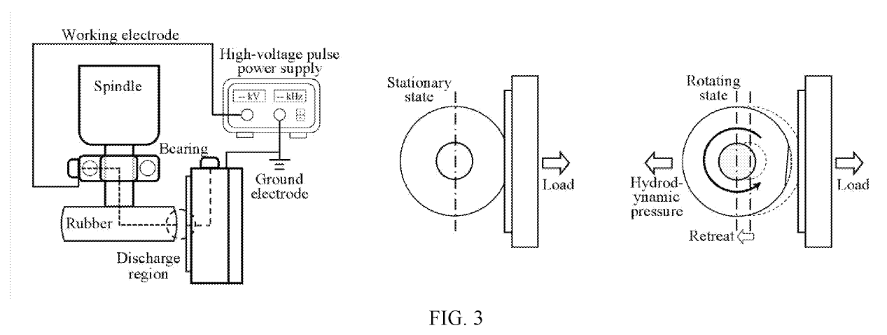

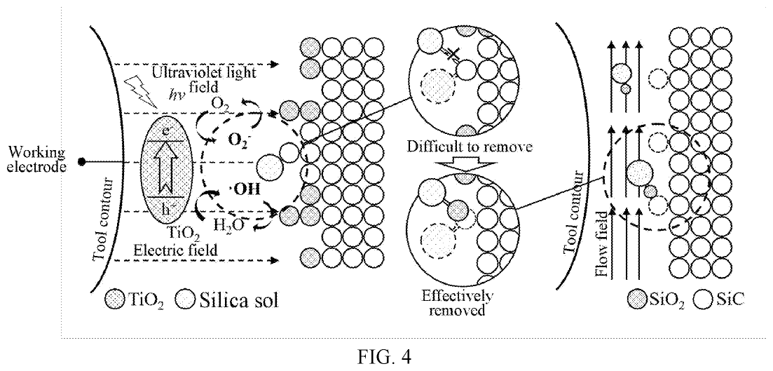

The above apparatus is used to polish a workpiece, which specifically includes the following steps:
Step 1: fixing a workpiece 102 to be processed on a surface of the workpiece base 104 by conductive adhesive. In this embodiment, the workpiece is doped conductive silicon carbide.
Step 2: controlling a position of the workpiece base 104 via the Y-axis translation stage 117 and the X-axis translation stage 118 such that the workpiece 102 comes into contact with a surface of the floating discharge tool 101. The water tank 105 containing polishing slurry is placed on the manual lifting stage 106. In this embodiment, the polishing slurry includes silica sol and titanium dioxide catalytic particles. A height of the manual lifting stage 106 is adjusted such that the polishing slurry in the water tank 105 immerses the floating discharge tool 101 and the workpiece 102, so as to generate sufficient hydrodynamic pressure for floating machining and provide a discharge medium for liquid-phase plasma discharge.
Step 3: as shown in FIG. 3, the spindle 115 is controlled to drive the floating discharge tool 101 to rotate, and hydrodynamic pressure generated by fluid action is balanced with a load applied on the aerostatic guide rail 112, the hydrodynamic pressure acting on the floating discharge tool 101 to cause the aerostatic guide rail 112 to drive the floating discharge tool 101 away from a surface of the workpiece 102 and to elastically deform the floating discharge tool 101, thereby forming a dynamically adjustable micron-scale stable liquid film gap between the floating discharge tool 101 and the workpiece 102.
Step 4: after the liquid film becomes stable, the adjustable power supply is turned on and discharge is initiated through the floating discharge tool 101. As shown in FIG. 4, the liquid-phase plasma discharge releases ultraviolet light and shock waves to provide energy for activating nano catalytic particles in the polishing slurry, enabling energy level transitions and generating electron-hole pairs, and an alternating electric field generated by the discharge further prolongs lifetimes of the electron-hole pairs, thereby generating various active species in a discharge region.

Electrons in the electron-hole pairs react with dissolved oxygen in water to generate superoxide anions and further react with hydrogen peroxide produced by the discharge to generate hydroxyl radicals, while holes react with water to generate hydroxyl radicals, thereby increasing a concentration of free radicals in the liquid film. The strongly oxidative free radicals in the liquid film convert a surface of the workpiece 102 into a softer oxide layer that is easier to remove.

Step 5: abrasive particles and catalytic particles in the polishing slurry pass through the liquid film gap at a relatively high linear velocity under fluid driving, come into contact with atoms on the surface of the workpiece 102 and form chemical bonds under shear stress, and are then removed together with fluid motion, thereby achieving deterministic material removal.

The above embodiment is merely intended to illustrate the technical concept and features of the present disclosure, and is provided to enable those skilled in the art to understand the content of the present disclosure and implement the same, and is not intended to limit the scope of protection of the present disclosure. Any equivalent modifications or variations made in accordance with the spirit of the present disclosure shall fall within the scope of protection of the present disclosure.

What is claimed is:

1. A liquid-phase plasma machining apparatus based on a floating discharge tool, comprising:
a workpiece base configured to fix a workpiece to be processed;
a working platform configured to hold a polishing slurry;
a spindle configured to drive a floating tool to rotate;
an aerostatic guide rail provided with a load and configured to support the spindle;
a Z-axis manual stage configured to fix the aerostatic guide rail;
a Y-axis translation stage and an X-axis translation stage configured to adjust a position of the workpiece base; wherein the floating tool is made of a flexible conductive material; the apparatus further comprises a conductive bearing, a ground electrode, a working electrode, and an adjustable power supply; the conductive bearing is sleeved over the floating tool and electrically connected to the adjustable power supply through the working electrode; and the workpiece base is disposed at a side of the floating tool and is grounded through the ground electrode.

2. The liquid-phase plasma machining apparatus according to claim 1, wherein the floating tool is fixed at one end of the spindle, and another end of the spindle is fixed to the aerostatic guide rail through a Z-axis bracket.

3. The liquid-phase plasma machining apparatus according to claim 1, wherein the adjustable power supply is a voltage-adjustable high-voltage pulse power supply, an alternating current power supply, or a direct current power supply.

4. The liquid-phase plasma machining apparatus according to claim 1, wherein the working platform is a liftable platform.

5. A liquid-phase plasma machining method based on a floating discharge tool, comprising using a liquid-phase plasma machining apparatus to polish a workpiece, the liquid-phase plasma machining apparatus comprising: a workpiece base configured to fix a workpiece to be processed; a working platform configured to hold a polishing slurry; a spindle configured to drive a floating tool to rotate; an aerostatic guide rail provided with a load and configured to support the spindle; a Z-axis manual stage configured to fix the aerostatic guide rail; a Y-axis translation stage and an X-axis translation stage configured to adjust a position of the workpiece base; wherein the floating tool is made of a flexible conductive material; and a conductive bearing, a ground electrode, a working electrode, and an adjustable power supply, wherein the conductive bearing is sleeved over the floating tool and electrically connected to the adjustable power supply through the working electrode, and the workpiece base is disposed at a side of the floating tool and is grounded through the ground electrode, the liquid-phase plasma machining method comprising:
fixing a workpiece to be processed on a surface of a workpiece base by a conductive adhesive;
controlling a position of the workpiece base via a Y-axis translation stage and an X-axis translation stage such that the workpiece is brought into contact with a surface of a floating tool, and placing a water tank containing a polishing slurry on the working platform such that the polishing slurry immerses the floating tool and the workpiece;
driving, by the spindle, the floating tool to rotate to form a dynamically adjustable micron-scale liquid film gap between the floating tool and the workpiece;
turning on the adjustable power supply after the liquid film becomes stable to initiate discharge; and
allowing abrasive particles in the polishing slurry to pass through the liquid film gap at a relatively high linear velocity under fluid driving, contact atoms on a surface of the workpiece to form chemical bonds, and then remove the atoms along with fluid motion, thereby achieving deterministic material removal.

6. The liquid-phase plasma machining method according to claim 5, wherein the workpiece is a semiconductor material or a metal material.

7. The liquid-phase plasma machining method according to claim 5, wherein the workpiece is doped conductive silicon carbide, silicon, zinc sulfide, gallium nitride, gallium arsenide, aluminum, iron, or copper.

8. The liquid-phase plasma machining method according to claim 5, wherein abrasive particles in the polishing slurry comprise one or more selected from the group consisting of silica sol, aluminum oxide, cerium oxide, diamond, and silicon carbide.

9. The liquid-phase plasma machining method according to claim 5, wherein the polishing slurry further comprises catalytic particles.

10. The liquid-phase plasma machining method according to claim 9, wherein the catalytic particles comprise one or more selected from the group consisting of titanium dioxide, graphitic carbon nitride, zinc oxide, and zirconium dioxide.
